(19) United States
(12) Patent Application Publication
(10) Pub. No.: US 2003/0191656 A1
(43) Pub. Date: Oct. 9, 2003

(54) Management of collaborative design process

(76) Inventor: Peter Ethan Staples, Hermosa Beach, CA (US)

Correspondence Address: TONG J. LEE, 1281 7TH PLACE, HERMOSA BEACH, CA, 90254, US

(21) Appl. No.: 10/118,118

(22) Filed: Apr. 6, 2002

(51) Int. Cl. G06F 7/00; G06F 17/60; G06F 17/00

(52) U.S. Cl. 705/1

(57) ABSTRACT

A collaborative design process is described. The management of the collaborative design process involves placing an incomplete design onto a secure website. An engineering authority for the various parts of the design is identified. Outside parties who agree to acknowledge the proprietary nature of the design may access the secure website, and may provide information relating to the completion of the design. The system that manages the design process may report one or more of the following: a number of services offered using the design, a number of units produced using the design, and a number of units sold using the design. Based on the reported numbers, the system may calculate an amount of payment owed by the outside party to the owner of the secure website.

### BACKGROUND

The Internet has proved to be a valuable tool for sharing design information between interested parties. Presently, the sharing of design information generally takes the form of transferring files from one engineer to another. Existing methods allow for exchanging completed designs between parties or incorporating one completed design into a lager, more complex design. There are significant benefits, however, to providing a way for various parties to access an incomplete design, i.e., a design that has not been fully developed to perform its intended function. Often there are parties that have a vested interest in making the design successful even though they are not actually responsible for the design itself. Examples of these interested parties are contract manufacturers and component suppliers. These parties are generally excluded from the design process until a design is completed. Their participation has the potential to enhance the design and speed up product development.

Overall, the existing methods may have the disadvantages which include, but are not limited to: a) outside parties are not allowed to witness the design at an incomplete stage; b) the engineers who are responsible for the specific portions of the design are not identified; c) the process of granting access to proprietary information is not automated; and d) current methods do not facilitate the payment of royalties by manufacturers that use the design information.

Groups adhering to open source programming techniques do grant full access to incomplete designs to the public. However, in so doing, their designs are no longer proprietary. This makes it difficult to obtain royalties from those who make commercial use of the design.

### SUMMARY

In one aspect, the invention relates to a design management method. The method may involve placing an incomplete design onto a secure website, identifying the engineers responsible for the various parts of the design, granting access to this website to outside parties who agree to acknowledge the proprietary nature of the design and treat it accordingly. The method may also include receiving information relating to the completion of the design from the outside party. A design is incomplete if it has not been fully developed to perform its intended function.

In another aspect, the invention relates to design management system. The system may include a secure website, a network, and one of more servers. The secure network may be accessible to an outside party when access is granted to the outside party. The network connects the outside party to the secure website through a firewall. The servers provide services to the secure website and perform the following operations: the servers place an incomplete design onto the secure website; identify an engineering authority responsible for a portion of the design on the secure website; grant access to the secure website to the outside party after the outside party acknowledges a proprietary treatment of the design as specified by an owner of the secure website; and receive information relating to the completion of the design from the outside party

In yet another aspect, the invention relates to a computer program product residing on a computer readable medium comprising instructions for causing the computer to: place an incomplete design onto a secure website; identify an engineering authority responsible for a portion of the design on the secure website; grant access to the secure website to an outside party after the outside party acknowledges a proprietary treatment of the design as specified by an owner of the secure website; and receive information relating to the completion of the design from the outside party.

Embodiments of the above aspects of the invention may include one or more of the following features. The outside party may directly contact the engineering authority. The design options under consideration may be displayed on the secure website. A webcasting of review events for the design may be provided. The method may further include reporting one or more of the following: a number of services offered using the design, a number of units produced using the design, and a number of units sold using the design. Based on the reported number of units produced or sold, an amount of payment is calculated. The amount of the payment is owed by the outside party to the owner of the secure website.

Embodiments may have one or more of the following advantages. The invention may allow outside parties to witness the design at an incomplete stage; identify the engineers who are responsible for the specific portions of the design; automate the process of granting access to proprietary information; and include payment mechanisms for manufacturers' use of design information.

Other features, objects, and advantages of the invention will be apparent from the description and drawings, and from the claims.

### BRIEF DESCRIPTION OF THE DRAWINGS

FIG. 1 shows basic components of a design management process;

FIG. 2 shows a flowchart of a membership process; and

FIG. 3 shows an example of a website layout used in the design management process.

Like reference symbols in the various drawings indicate like elements.

### DETAILED DESCRIPTION

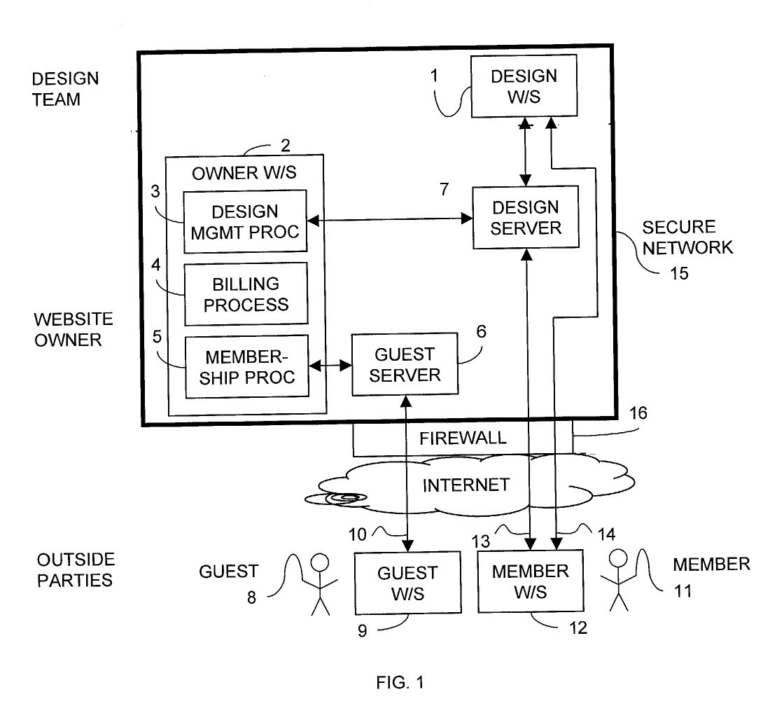

As shown in FIG. 1, the invention pertains to the exchange of information between three groups: a design team, a website owner, and outside parties. The design team includes a collection of one or more processors (e.g. workstations) including a design workstation 1. The website owner controls one or more workstations, including owner workstation 2 and two or more data servers, including servers 6 and 7. Data servers are workstations specially designed to disseminate hypertext markup language (HTML) files, otherwise known as webpages, to other workstations. Outside parties include guests (such as a guest 8) and members (such as a member 11), each with a workstation (workstations 9 and 12 respectively).

Design workstation 1 is connected to design server 7. Via this connection, the design team uploads design information from design workstation 1 to design server 7. Owner workstation 2 is running three processes: a membership process 5, a design management process 3, and a billing process 4. Design management process 3 and billing process 4 are connected to design server 7. Membership process 5 is connected to guest server 6.

The design team and the website owner are part of a secure network 15 behind a firewall 16. Firewall 16 is software running on a standalone computer (as shown in FIG. 1) or running simultaneously on servers 6 and 7 and design workstation 1. This software prevents unauthorized access of secure network 15 and the design information therein. Any outside party attempting to access secure network 15 encounters firewall 16. An outside party is either guest 8 or member 11. If the outside party is a member, he enters a member identification and password. Firewall 16 makes a query to a database (not pictured) to determine whether the outside party is indeed a member. If membership is confirmed, member 11 can use a workstation 12 to access design server 7 via a connection 13 through firewall 16. If membership cannot be confirmed, the outside party is classified as a guest. Guest 8 only has access to guest server 6. Using a workstation 9, guest 8 accesses guest server 6 via a connection 10 through firewall 16. Member workstation 12 is also connected to design workstation 1 for the purpose of sending direct feedback to the design team. This connection 14 is also through firewall 16. Although the embodiment in FIG. 1 has two distinct links 13, 14 between member workstation 12 and design workstation 1, in some scenarios member workstation 12 can communicate with design workstation 1 via design server 7 and connection 13.

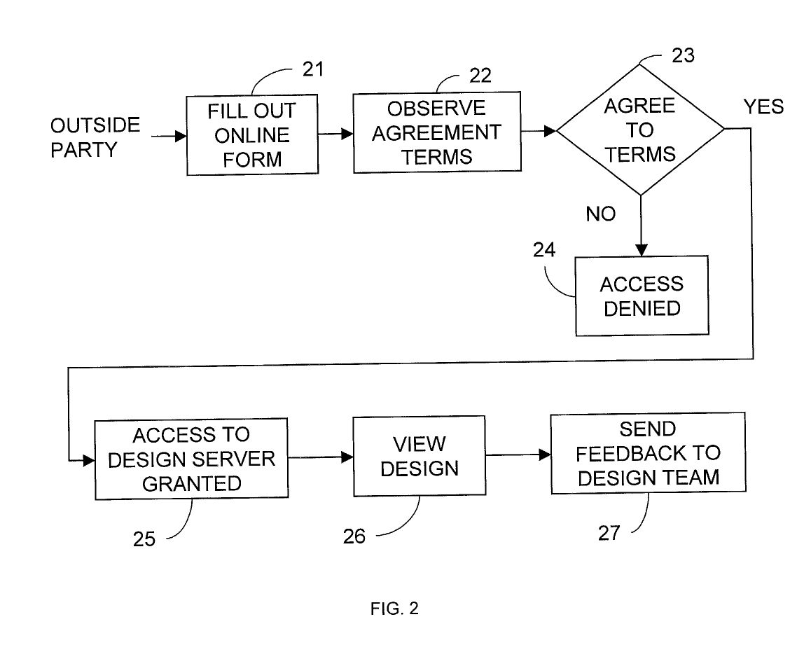

FIG. 2 shows an example of the steps of membership process 5. Any guest may become a member via membership process 5. This process requires the exchange of data between guest workstation 9, membership process 5 (running on owner workstation 2), and guest server 6. First, guest 8 (i.e., the outside party in FIG. 2) goes to guest server 6 and provides contact information via an online form (box 21). Guest 8 views an agreement sent by guest server 6 on guest workstation 9 (box 22). The agreement defines the terms, set by the website owner, for viewing the designs. When guest 8 acknowledges these terms (box 23), he becomes a member and gains access to design server 7 (box 25). Guest 8 may then view the designs (box 26). The agreements are archived in owner workstation 2 (as shown in FIG. 1) or in a separate database within secure network 15. If guest 8 does not agree to the terms (box 23), he remains a guest and is denied access to design server 7 (box 24). Design information on design server 7 includes contact information for the engineers on the design team. Member 11 may contact the design team directly to ask questions or provide comments about the design (box 27).

Design information is made available on webpages stored on design server 7. An engineering authority for the overall design is identified on such a webpage. An example of this identification is a hyperlink label. A hyperlink is an electronic link providing direct access from one distinctively marked place on a webpage. An engineering authority is also identified for each component of the design. Alternatives for various design parameters are also displayed on a webpage. The design parameters are shown as options under consideration for each of the components. The engineering authority is the person responsible for selecting the best option for his component. Members who view the design can contact the engineering authority of the overall design or of specific components via the appropriate hyperlink. This is an example of how the engineers receive feedback on the design. If member 11 happens to be a supplier of a component in the design, he is motivated to provide updated information on that component to the relevant engineering authority.

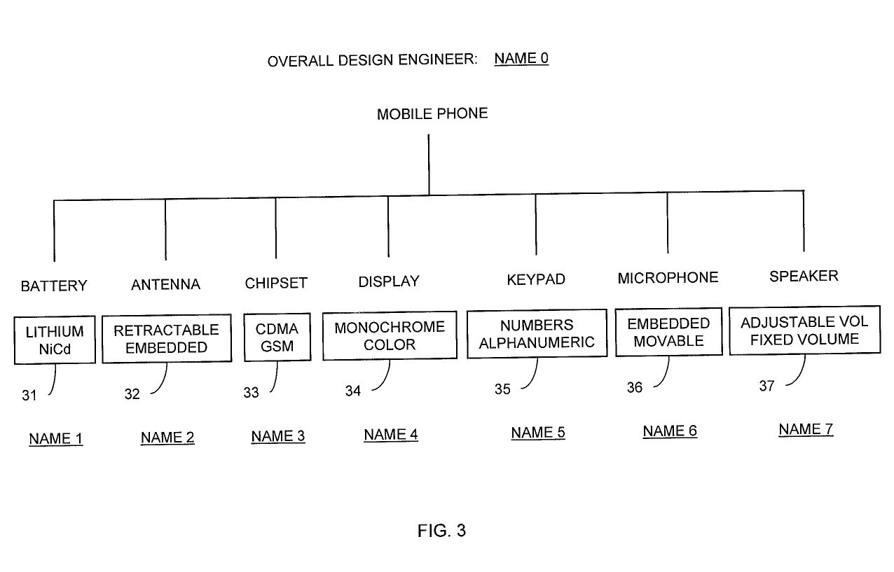

FIG. 3 shows an embodiment of the design management process for designing a mobile telephone. A mobile telephone has several essential components such as the battery 31, antenna 32, chipset 33, display 34, keypad 35, microphone 36, and speaker 37. For each component, multiple options may exist. As part of the design method, one of the webpages stored on design server 7 displays—for each component—the component name, the list of options under consideration, and an engineering authority (i.e., NAME 1-NAME 7) responsible for selecting the best option. This webpage is made available to everyone who has completed membership process 5. In FIG. 3, two options are listed under battery 31: lithium and nickel cadmium. If a maker of lithium batteries is a member and observes the webpage, he may see who is responsible (i.e., NAME 1) for deciding on the battery used in the mobile phone design. Thus, the battery maker may have a direct means of contacting this engineer. The battery maker may be able to alert the engineer to new product offerings, test results, pricing information, or other information relating to the completion of the design. When this information is combined with similar data from competing battery vendors, the engineer is in a better position to select the optimal design. In addition to component suppliers, manufacturers are an important group of members. Manufacturers of the final product (e.g., mobile telephones in this case) may be able to provide useful insight to the costs of integrating and producing the device. This information may be valuable to the design team and the owner since they want manufacturers ultimately to use the design, make the product, and pay royalties.

A mobile phone is just one possible design. Design management process 3 may be applied to numerous other things including but not limited to integrated circuits, heavy equipment, and medical devices.

Manufacturers are the customers of the designs since they pay royalties for using the designs. The manufacturers are likely to visit the website repeatedly for the purpose of planning out production runs and perhaps influencing the design to make it suited to their manufacturing methods. Manufacturers who use the completed design pay a predetermined royalty to the website owner. The amount of the payment is computed as part of billing process 4. Billing process 4 requires the interaction between member workstation 12, design server 7, and owner workstation 2. An example of this interaction is described below.

In one embodiment, the royalty is set at $0.50 per unit produced. The number of units produced by the manufacturer is measured and recorded on member workstation 12. Suppose this number is 100,000. This information is sent from member workstation 12 to billing process 4 via design server 7. Billing process 4 takes the number of units produced (100,000) and the royalty of $0.50 per unit produced and computes a payment of $50,000 payable by the manufacturer to the website owner.

Accordingly, other embodiments are within the scope of the following claims.

1. A design management method comprising:
placing an incomplete design onto a secure website wherein the incomplete design has not been fully developed to perform an intended function;
identifying an engineering authority responsible for a portion of the design on the secure website;
granting access to the secure website to an outside party after the outside party acknowledges a proprietary treatment of the design as specified by an owner of the secure website; and
receiving information relating to the completion of the design from the outside party.

2. The method of claim 1 further comprising providing a means for the outside party to directly contact the engineering authority.

3. The method of claim 1 further comprising displaying design options under consideration on the secure website.

4. The method of claim 1 further comprising providing a webcasting of review events for the design.

5. The method of claim 1 further comprising reporting a number of services offered using the design.

6. The method of claim 1 further comprising reporting a number of units produced using the design.

7. The method of claims 6 further comprising calculating a payment based on the reported number of units, the amount of the payment being owed by the outside party to the owner of the secure website.

8. The method of claim 1 further comprising reporting a number of units sold using the design.

9. The method of claims 8 further comprising calculating a payment based on the reported number of units, the amount of the payment being owed by the outside party to the owner of the secure website.

10. A design management system comprising:
a secure website, that is accessible to an outside party when access is granted to the outside party;
a network, that connects the outside party to the secure website through a firewall;
one or more servers servicing the secure website, wherein the servers
place an incomplete design onto the secure website wherein the incomplete design has not been fully developed to perform an intended function;
identify an engineering authority responsible for a portion of the design on the secure website;
grant access to the secure website to the outside party after the outside party acknowledges a proprietary treatment of the design as specified by an owner of the secure website; and
receive information relating to the completion of the design from the outside party.

11. The system of claim 10 wherein the secure website provides a selectable link for the outside party to directly contact the engineering authority.

12. The system of claim 10 wherein the secure website displays design options under consideration.

13. The system of claim 10 wherein the secure website provides a webcasting of review events for the design.

14. The system of claim 10 wherein the secure website reports a number of services offered using the design.

15. The system of claim 10 wherein the secure website reports a number of units produced using the design.

16. The system of claims 15 wherein the servers calculate a payment based on the reported number of units, the amount of the payment being owed by the outside party to the owner of the secure website.

17. The system of claim 10 wherein the secure website reports a number of units sold using the design.

18. The system of claims 17 wherein the servers calculate a payment based on the reported number of units, the amount of the payment being owed by the outside party to the owner of the secure website.

19. A computer program product residing on a computer readable medium comprising instructions for causing the computer to:
place an incomplete design onto a secure website wherein the incomplete design has not been fully developed to perform an intended function;
identify an engineering authority responsible for a portion of the design on the secure website;
grant access to the secure website to an outside party after the outside party acknowledges a proprietary treatment of the design as specified by an owner of the secure website; and
receive information relating to the completion of the design from the outside party.

20. The computer program product of claim 19 further comprising instructions for causing the computer to provide a selectable link for the outside party to directly contact the engineering authority.
